(19) United States
(12) Patent Application Publication
(10) Pub. No.: US 2022/0302448 A1
(43) Pub. Date: Sep. 22, 2022

(54) ELECTRODE, SECONDARY BATTERY, BATTERY PACK, AND VEHICLE

(71) Applicant: KABUSHIKI KAISHA TOSHIBA, Tokyo (JP)

(72) Inventors: Keigo HOSHINA, Yokohama (JP); Yasunobu YAMASHITA, Tokyo (JP); Yasuhiro HARADA, Isehara (JP); Norio TAKAMI, Yokohama (JP)

(73) Assignee: KABUSHIKI KAISHA TOSHIBA, Tokyo (JP)

(21) Appl. No.: 17/461,009

(22) Filed: Aug. 30, 2021

(30) Foreign Application Priority Data
Mar. 22, 2021 (JP) 2021-047750

(51) Int. Cl. H01M 4/525; H01M 4/583; H01M 10/42

(52) U.S. Cl. CPC H01M 4/525; H01M 4/583; H01M 10/425; H01M 2004/021

(57) ABSTRACT

According to one embodiment, provided is an electrode including an active material-containing layer, which includes a titanium-niobium composite oxide, a fibrous carbon material, and one or more thickener selected from the group consisting of carboxymethyl cellulose, carboxymethyl cellulose salts, and polyvinyl pyrrolidone. In a particle size distribution of particles in the active material-containing layer, an average particle size D₅₀ is from 1.6 μm to 3.0 μm, a particle size D₁₀ is 1 μm or less, and a particle size D₉₀ is 10 μm or more. The particle size distribution includes a first peak having a maximum peak intensity I_{MAX} corresponding to a maximum frequency and a second peak positioned at 10 μm or more. The second peak has a peak intensity I_{2nd} of 0.25 I_{MAX} to 0.7 I_{MAX}.

### CROSS-REFERENCE TO RELATED APPLICATION

This application is based upon and claims the benefit of priority from Japanese Patent Application No. 2021-047750, filed Mar. 22, 2021, the entire contents of which is incorporated herein by reference.

### FIELD

Embodiments relate to an electrode, secondary battery, battery pack, and vehicle.

### BACKGROUND

In recent years, as a high energy density battery, secondary batteries such as a lithium-ion secondary battery or a nonaqueous electrolyte secondary battery have been developed. The secondary battery is anticipated for use as a power source for vehicles such as a hybrid electric automobile and an electric automobile, or as a large-sized power source for power storage. When the secondary battery is used as the power source for vehicles, the secondary battery is demanded to achieve rapid charge/discharge performance and long-term reliability or the like in addition to the high energy density.

Rapid charge and discharge is enabled by lithium ions and electrons rapidly moving respectively through an electrolyte and an external circuit, between a positive electrode and a negative electrode that are able to have lithium ions and electrons be inserted and extracted. The battery capable of performing rapid charge/discharge has the advantage that a charging time is considerably short. When the battery capable of performing rapid charge/discharge is used as the power source for vehicles, the motive performances of the automobile can be improved, and the regenerative energy of power can be efficiently recovered.

As a negative electrode that can have lithium ions and electrons be inserted and extracted, a carbon-based negative electrode using a carbonaceous material such as graphite as a negative electrode active material is in use. However, when rapid charge and discharge is repeated in a battery including the carbon-based negative electrode, dendrites of metallic lithium may precipitate on the negative electrode. The dendrites of metal lithium may cause an internal short circuit. Therefore, when the rapid charge and discharge is repeated in the battery including the carbon-based negative electrode, a concern is raised that heat generation and ignition may occur.

Therefore, a battery including a negative electrode using a metal composite oxide as the negative electrode active material in place of the carbonaceous material has been developed. In particular, in a battery using a titanium oxide as the metal composite oxide for the negative electrode active material, the dendrites of metal lithium are less likely to precipitate even when rapid charge/discharge is repeated as compared with those of the battery including the carbon-based negative electrode. The battery using the titanium oxide has more stable rapid charge/discharge and a longer life than those of the battery including the carbon-based negative electrode.

However, the titanium oxide has a higher (more noble) potential relative to lithium metal than that of the carbonaceous material. On top of that, the titanium oxide has a lower theoretical capacity per unit mass than that of the carbonaceous material. Therefore, there is a problem that the battery including a negative electrode using the titanium oxide as the negative electrode active material has a lower energy density than that of the battery including the carbon-based negative electrode.

As a metal composite oxide with enhanced energy density, an electrode material containing titanium and niobium has been considered. In particular, in a monoclinic titanium-niobium composite oxide represented by TiNb₂O₇, while tetravalent titanium ions are reduced to trivalent titanium ions when lithium ions are inserted, pentavalent niobium ions are reduced to trivalent niobium ions, also. Therefore, this monoclinic titanium-niobium composite oxide can maintain the electric neutrality of a crystal structure even when many lithium ions are inserted, as compared with the titanium oxide. As a result, the monoclinic titanium-niobium composite oxide represented by TiNb₂O₇ has a high theoretical capacity of 387 mAh/g.

Titanium-niobium composite oxide has relatively low electrical conductivity. One measure for compensating for the low electrical conductivity of the titanium-niobium composite oxide is to blend fibrous carbon materials such as carbon nanotubes into the electrode. As compared with granular carbon such as carbon black, fibrous carbon materials have many contact points with active material particles and can provide an electrical conductive path over a long distance, and thereby enhance the electron conductivity of the electrode.

### BRIEF DESCRIPTION OF THE DRAWINGS

FIG. 1 is a cross-sectional view schematically showing an example of an electrode according to an embodiment;

FIG. 2 is a graph showing a particle size distribution for an example of the electrode according to the embodiment;

FIG. 3 is a graph showing a particle size distribution for an example of a slurry used to fabricate the electrode according to the embodiment;

FIG. 4 is a cross-sectional view schematically showing an example of a secondary battery according to an embodiment;

FIG. 5 is an enlarged cross-sectional view of section A of the secondary battery shown in FIG. 4;

FIG. 6 is a partially cut-out perspective view schematically showing another example of the secondary battery according to an embodiment;

FIG. 7 is an enlarged cross-sectional view of section B of the secondary battery shown in FIG. 6;

FIG. 8 is a perspective view schematically showing an example of a battery module according to an embodiment;

FIG. 9 is an exploded perspective view schematically showing an example of a battery pack according to an embodiment;

FIG. 10 is a block diagram showing an example of an electric circuit of the battery pack shown in FIG. 9;

FIG. 11 is a partially see-through diagram schematically showing an example of a vehicle according to an embodiment;

FIG. 12 is a diagram schematically showing an example of a control system related to an electric system in the vehicle according to an embodiment; and

FIG. 13 is a graph showing a particle size distribution of a slurry prepared for fabricating an electrode in Comparative Example 1.

### DETAILED DESCRIPTION

According to one embodiment, provided is an electrode including an active material-containing layer, which includes a titanium-niobium composite oxide, a fibrous carbon material, and one or more thickener selected from the group consisting of carboxymethyl cellulose, carboxymethyl cellulose salts, and polyvinyl pyrrolidone. In a particle size distribution of particles included in the active material-containing layer according to a laser diffraction scattering method, an average particle size D₅₀ is from 1.6 μm to 3.0 μm, a particle size D₁₀ at which cumulative frequency from a small particle size side is 10% is 1 μm or less, and a particle size D₉₀ at which cumulative frequency from the small particle size side is 90% is 10 μm or more. Moreover, the particle size distribution includes a first peak having a maximum peak intensity I_{MAX} corresponding to a maximum frequency in the particle size distribution and a second peak positioned at 10 μm or more. The second peak has a peak intensity I_{2nd} of 0.25 I_{MAX} to 0.7 I_{MAX} with respect to the maximum peak intensity I_{MAX}.

According to another embodiment, provided is a secondary battery including a negative electrode, a positive electrode, and an electrolyte. The negative electrode includes the electrode according to the above embodiment.

According to a further other embodiment, provided is a battery pack including the secondary battery according to the above embodiment.

According to still another embodiment, provided is a vehicle including the battery pack according to the above embodiment.

Although the electron conductivity of the electrode can be enhanced by including a fibrous carbon material in the electrode, when the fibrous carbon material is added to the electrode, uniform dispersion of the active material is difficult. Forceful dispersion becomes necessary in order to make the fibrous carbon material intertwine among titanium-niobium composite oxide particles, which, however, leads to excessive dispersion. When the strength of the dispersion is decreased to prevent excessive dispersion, formation of an electro-conductive path may be insufficient, whereby charge-discharge cycle performance may decrease. For example, when the fibrous carbon material cannot thread-in between the particles of the active material, whereby the particles of the active material or the fibrous carbon materials largely agglomerate, the distributions of the active material and the fibrous carbon material will have bias. When the distributions of these materials are not uniform, the reaction distribution and the electro-conductive path in the electrode will be non-uniform, causing a decrease in cycle performance.

According to one or more embodiments described hereinafter, the distributions of the fibrous carbon material and the active material particles in the electrode are uniform.

Hereinafter, embodiments will be described with reference to the drawings. The same reference signs are applied to common components throughout the embodiments and overlapping explanations are omitted. Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to a first embodiment, an electrode is provided. The electrode includes an active material-containing layer that includes a titanium-niobium composite oxide, a fibrous carbon material, and a thickener. The thickener includes one or more selected from the group consisting of carboxymethyl cellulose, carboxymethyl cellulose salts, and polyvinyl pyrrolidone. In a particle size distribution with respect to particles included in the active material-containing layer according to a laser diffraction scattering method, an average particle size D₅₀ is from 1.6 μm to 3.0 μm, a particle size D₁₀ at which cumulative frequency from a small particle size side is 10% is 1 μm or less, and a particle size D₉₀ at which cumulative frequency from the small particle size side is 90% is 10 μm or more. The particle size distribution of the active material-containing layer includes a first peak and a second peak. The first peak has a maximum peak intensity I_{MAX} corresponding to a maximum frequency in the particle size distribution. The second peak is positioned in a region of 10 μm or more in the particle size distribution. The second peak has a peak intensity I_{2nd} of 0.25 I_{MAX} to 0.7 I_{MAX} with respect to the maximum peak intensity I_{MAX}.

The electrode according to the embodiment may be an electrode for a battery, for example. The battery, for which the electrode is used, may be a secondary battery such as a lithium secondary battery, for example. The secondary battery as described herein includes nonaqueous electrolyte secondary batteries containing nonaqueous electrolyte(s). As a specific example, the electrode may be an electrode for a nonaqueous electrolyte battery, having an active material-containing layer (electrode layer) disposed on a foil-shaped current collector (current collector foil). The electrode may be included in a battery as a negative electrode.

The active material-containing layer includes the titanium-niobium composite oxide as an electrode active material, and at least includes the fibrous carbon material as an electro-conductive agent. The active material-containing layer also includes one or more thickener selected from the group consisting of carboxymethyl cellulose, carboxymethyl cellulose salts, and polyvinyl pyrrolidone. In addition to the active material, fibrous carbon material, and thickener, the active material-containing layer may further include, for example, other electrode-conductive agents and a binder.

The electrode may further include a current-collector. The active material-containing layer may be disposed on at least one principal surface of the current collector, for example. The active material-containing layer may be disposed on one principal surface of the current collector. Alternatively, the active material-containing layer may be disposed on two principal surfaces of the current collector, for example, both of reverse surfaces of the current collector having a foil shape.

The current collector may include a portion that does not have the active material-containing layer formed on a surface thereof. This portion can serve as a current collecting tab.

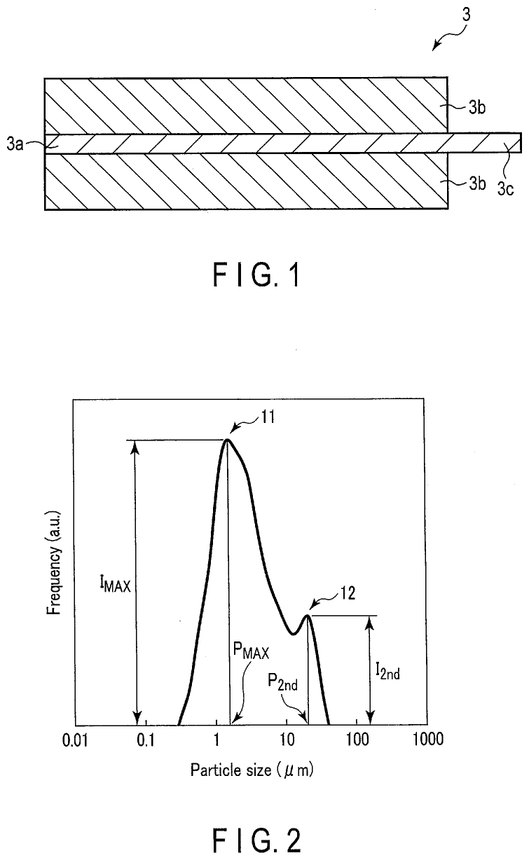

A specific example of the electrode according to the embodiment is shown in FIG. 1. FIG. 1 is a cross-sectional view schematically showing an example of the electrode according to the embodiment. With the example shown in FIG. 1, an aspect of the electrode as a negative electrode of a battery will be described. FIG. 1 is a cross-sectional view representing a cross-section intersecting a principal surface of a negative electrode 3.

The negative electrode 3 shown in FIG. 1 includes a negative electrode current collector 3a and a negative electrode active material-containing layer 3b disposed on the negative electrode current collector 3a. The negative electrode current collector 3a includes a portion 3c that does not support the negative electrode active material-containing layer 3b thereon, that is, a negative electrode current collecting tab 3c. In the example shown, the negative electrode active material-containing layer 3b is supported on both principal surfaces on the front and reverse surfaces of the negative electrode current collector 3a. The negative electrode 3 may be an electrode with the negative electrode active material-containing layer 3b supported only on one face of the negative electrode current collector 3a.

The active material-containing layer includes the titanium-niobium composite oxide in the form of particles, for example. The active material-containing layer may also include particles of other electrode active materials in addition to the titanium-niobium composite oxide particles. The particle size of such active material particles (titanium-niobium composite oxide particles, or titanium-niobium composite oxide particles and other electrode active material particles) is mainly reflected in the particle size distribution according to the laser diffraction scattering method for particles included in the active material-containing layer.

The particle size distribution of the particles included in the active material-containing layer according to a laser diffraction scattering method is obtained by measuring a dispersion solution obtained by dissolving the active material-containing layer in water. Details of the measurement conditions will be described later. A spectrum representing the obtained particle size distribution corresponds to a histogram for the particles included in the active material-containing layer. Specifically, the particle size distribution represents a frequency of the presence of the particles included in the active material-containing layer for each particle size based on the volume. In the above electrode, an average particle size D₅₀, that is, a particle size at which cumulative frequency (volume accumulation) from the small particle size side is 50% is from 1.6 μm to 3.0 μm, a particle size D₁₀ at which cumulative frequency (volume accumulation) from the small particle size side is 10% is 1 μm or less, and a particle size D₉₀ at which cumulative frequency (volume accumulation) from the small particle size side is 90% is 10 μm or more, in this particle size distribution spectrum. The average particle size D₅₀ may be an average primary particle size of the active material particles (titanium-niobium composite oxide particles, or titanium-niobium composite oxide particles and other electrode active material particles). The particle size D₁₀ at 10% volume accumulation is preferably 0.4 μm or more. The particle size D₉₀ at 90% volume accumulation is preferably 18 μm or less.

The particle size distribution spectrum includes two peaks. One of the two peaks has a peak top at a position closer to the average particle size D₅₀, and has a maximum intensity within the spectrum. The position of the peak top of this first peak corresponds to the particle size appearing at a maximum frequency in the particle size distribution, and the peak intensity of the first peak corresponds to the maximum frequency in the particle size distribution. Namely, the position of the first peak corresponds to the mode diameter in the particle size distribution. Herein, the peak intensity of the first peak is referred to as a “maximum peak intensity I_{MAX}”.

The other of the two peaks in the particle size distribution spectrum has a peak top in a region corresponding to a particle size of 10 μm or more. This second peak has the second highest intensity within the spectrum. The peak intensity I_{2nd} of the second peak takes a value in the range of 0.25 I_{MAX} to 0.7 I_{MAX} with respect to the maximum peak intensity I_{MAX}. Namely, an intensity ratio I_{2nd}/I_{MAX} of the peak intensity I_{2nd} of the second peak to the maximum peak intensity I_{MAX}, which is also the first peak intensity, is within the range of 0.25 to 0.7.

In the active material-containing layer exhibiting the above-described particle size distribution, particle materials including the active material and the fibrous carbon material are dispersed uniformly. Therefore, a secondary battery which adopts the electrode according to the embodiment can exhibit excellent life performance.

The first peak included in the particle size distribution may mainly reflect the active material particles dispersed again as primary particles when the active material-containing layer is dissolved for measuring the particle size distribution. The second peak may represent the active material particles tangled with the fibrous carbon material. The peak intensity I_{2nd} of the second peak being in the range of 0.25 I_{MAX} to 0.7 I_{MAX} described above may indicate that an electro-conductive path by the fibrous carbon material thoroughly spans among the active material particles and that excessive agglomeration has not occurred.

An example of the particle size distribution obtained for the electrode according to the embodiment is shown in FIG. 2. FIG. 2 is a graph showing a particle size distribution of an example of the electrode according to the embodiment. In the particle size distribution spectrum shown as an example, the particle size D₁₀ is 0.78 μm, the average particle size D₅₀ is 2.39 μm, and the particle size D₉₀ is 14.8 μm. The spectrum has a first peak 11 and a second peak 12 respectively corresponding to a maximum value and a local maximum value of the frequency of the particle size. A peak top position P_{MAX} of the first peak 11, which is a peak with the greatest intensity, is near 1 μm. A peak top position P_{2nd} of the second peak 12 is in a region of 10 μm or more. The peak intensity I_{2nd} of the second peak with respect to the maximum peak intensity I_{MAX} of the first peak 11 exhibiting the maximum intensity is 0.37 I_{MAX} (I_{2nd}/I_{MAX}=0.37).

The titanium-niobium composite oxide contained in the active material-containing layer may include a titanium-niobium composite oxide having a monoclinic crystal structure. An example of titanium-niobium composite oxide of the monoclinic structure includes a compound represented by LiₐTi₁₋ₓM1ₓNb_{2-y}M2_{y}O_{7-δ}. In general formula LiₐTi₁₋ₓM1ₓNb_{2-y}M2_{y}O_{7-δ}, subscript a is within a range of 0≤a<5, subscript x is within a range of 0≤x<1, subscript y is within a range of 0≤y<1, and subscript δ is within a range of −0.3≤δ≤0.3. Elements M1 and M2 are respectively at least one selected from the group consisting of Mg, Fe, Ni, Co, W, Ta, and Mo. Elements M1 and M2 are elements that are the same or different from one another. It is preferable to include the above LiₐTi₁₋ₓM1ₓNb_{2-y}M2_{y}O_{7-δ} as titanium-niobium composite oxide. A specific example of monoclinic titanium-niobium composite oxide is LiₐTiNb₂O₇ (0≤a<5).

The titanium-niobium composite oxide may include a titanium-niobium composite oxide having an orthorhombic crystal structure. An example of titanium-niobium composite oxide of the orthorhombic structure includes a compound represented by Li₂₊ₛNa₂₋ₜM3ᵤTi_{6-v-w}NbᵥM4_{w}O_{14+σ}. In general formula Li₂₊ₛNa₂₋ₜM3ᵤTi_{6-v-w}NbᵥM4_{w}O_{14+σ}, subscript s is within a range of 0≤s≤4, subscript t is within a range of 0<t<2, subscript u is within a range of 0≤u<2, subscript v is within a range of 0<v<6, subscript w is within a range of 0≤w<3, a sum of the subscript v and the subscript w is within a range of 0<v+w<6, and subscript σ is within a range of −0.5≤σ≤0.5. Element M3 is at least one selected from the group consisting of Cs, K, Sr, Ba and Ca. Element M4 is at least one selected from the group consisting of Zr, Sn, V, Ta, Mo, W, Fe, Mn and Al.

The active material-containing layer may contain a single species of titanium-niobium composite oxide independently or may contain two or more species of titanium-niobium composite oxides. For example, the active material-containing layer may include both a monoclinic titanium-niobium composite oxide and an orthorhombic titanium-niobium composite oxide. In addition to a single species of titanium-niobium composite oxide or two or more species of titanium-niobium composite oxides, the active material-containing layer may contain another species of electrode active material or two or more species of other electrode active materials. Examples of other electrode active materials include lithium titanium oxide having a spinel structure (for example, lithium titanate represented by Li_{4+z}Ti₅O₁₂ where 0≤z≤3), titanium dioxide (TiO₂), anatase titanium dioxide, rutile titanium dioxide, niobium pentoxide (Nb₂O₅), hollandite titanium composite oxide, and lithium titanium oxide having a ramsdellite structure (for example, Li_{2+z}Ti₃O₇, 0≤z≤3). In particular, it is preferable to use lithium titanium oxide having a spinel structure in combination with titanium-niobium composite oxide(s). A content of titanium-niobium composite oxide(s) with respect to the total mass of electrode active material including the titanium-niobium composite oxide(s) and other electrode active materials in the active material-containing layer is desirably from 50% by mass to 100% by mass.

The electrode includes a fibrous carbon material as an electro-conductive agent. The electro-conductive agent is added to improve current collecting performance and to suppress the contact resistance between the active material and the current collector. Examples of the fibrous carbon material include vapor grown carbon fiber (VGCF), carbon nanofiber, and carbon nanotube. One of these may be used as the electro-conductive agent, or two or more of these may be used in combination as the electro-conductive agent.

In addition to the one fibrous carbon material or two or more fibrous carbon materials, one other electro-conductive agent or two or more other electro-conductive agents may be included in the active material-containing layer. For example, carbon materials in the form of particles may be used as other electro-conductive agents. Examples of such particulate electro-conductive agents include carbon black such as acetylene black and graphite. For example, plate-shaped or flaky carbon materials including graphene may also be used as other electro-conductive agents. Such non-fibrous other electro-conductive agents fill gaps which may be formed between composites formed of the active material particles and the fibrous carbon material(s), and thus can improve the electron conductivity of the active material-containing layer. Therefore, it is preferable to include other electro-conductive agents in addition to the fibrous carbon material(s). In addition to including the electro-conductive agent, a carbon coating or an electron-conductive inorganic material coating may also be applied to the surface of the active material particles.

The thickener functions to bond the active material and the electro-conductive agent. The thickener also contributes to improvement of the uniformity of the active material-containing layer. Specifically, a slurry including materials such as active materials is used, for example, to form the active material-containing layer as described later, and adding the thickener to the slurry can improve the viscosity of the slurry thereby enhancing the productivity. Also, adding the thickener improves the dispersion of the carbon materials, which leads to better dispersion of the fibrous carbon material or other electro-conductive agents in the slurry, and accordingly a better distribution of the fibrous carbon material or other electro-conductive agents in the active material-containing layer. Namely, adding the thickener leads to preventing agglomeration of the active materials, making the reaction distribution in the electrode uniform. One, or two or more selected from the group consisting of carboxymethyl cellulose (CMC), salts of carboxymethyl cellulose, and polyvinyl pyrrolidone (PVP) may be used as the thickener. For example, sodium salt of CMC (CMCNa) can be cited as a carboxymethyl cellulose salt.

The binder may be added to fill gaps among the dispersed active materials or fibrous carbon materials and also to bind the active materials and the fibrous carbon materials with the current collector. Examples of the binder include water-soluble binders such as fluororubber, styrene-butadiene rubber (SBR), polyacrylic acid (PAA), and polyacrylonitrile (PAN). One of these may be used as the binder, or two or more of these may be used in combination as the binder.

The blending proportions of the active material, fibrous carbon material, other electro-conductive agents, thickener, and binder in the active material-containing layer is preferably as follows: 0.2 parts by mass to 3 parts by mass of the fibrous carbon material, 1 part by mass to 6 parts by mass of other electro-conductive agents (such as acetylene black), 1 part by mass to 4 parts by mass of the thickener (such as CMC), and 0.5 parts by mass to 3 parts by mass of the binder (such as SBR), with respect to 100 parts by mass of the active material (titanium-niobium composite oxide, or titanium-niobium composite oxide and other electrode active materials).

There may be used for the current collector, a material which is electrochemically stable at the potential (vs. Li/Li⁺) at which lithium (Li) is inserted into and extracted from the active material. For example, in the case where the electrode is used as a negative electrode, the current collector is preferably made of copper, nickel, stainless steel, aluminum, or an aluminum alloy including one or more selected from the group consisting of Mg, Ti, Zn, Mn, Fe, Cu, and Si. The thickness of the current collector is preferably from 5 μm to 20 μm. The current collector having such a thickness can maintain balance between the strength and weight reduction of the electrode.

### Measurement Methods

Measuring methods concerning the electrode are described below. Specifically, a method of examining the active material included in the electrode and the method of measuring the particle distribution of particles included in the active material-containing layer will be explained.

When measuring an electrode that is configured into a battery, the electrode is taken out of the battery by the following procedure.

First, the battery is put into a discharged state. The discharged state as described herein refers to a state where the battery is subjected to a constant current discharge under a 25° C. environment at a current value of 0.2 C or less, to a discharge lower limit voltage. The battery put into the discharged state is placed into a glove box of inert atmosphere, for example, a glove box filled with argon gas. Next, within the glove box, the target electrode is taken out from the battery. Specifically, within the glove box, the exterior of the battery is cut open, taking care not to short-circuit the positive electrode with the negative electrode, just in case. From the cut-open battery, for example, the electrode connected to the negative electrode-side terminal is cut out, in the case that the electrode used as negative electrode is to be made the measurement sample. The electrode thus taken out is washed, for example, with an ethyl methyl ether solution, then dried.

### Method of Examining Active Material

The composition of active material included in the electrode, for example, in the active material-containing layer can be examined by combining elemental analysis with a scanning electron microscope equipped with an energy dispersive X-ray spectrometry scanning apparatus (scanning electron microscope-energy dispersive X-ray spectrometry; SEM-EDX), X-ray diffraction (XRD) measurement, and inductively coupled plasma (ICP) emission spectrometry. By SEM-EDX analysis, shapes of components contained in the active material-containing layer and compositions of the components contained in the active material-containing layer (each element from B to U in the periodic table) can be known. The elements in the active material-containing layer can be quantified by ICP. Crystal structures of materials included in the active material-containing layer can be examined by XRD measurement.

A cross-section of the electrode extracted as described above is cut out by Ar ion milling. The cutout cross-section is observed with the SEM. Sampling is also performed in an inert atmosphere such as argon or nitrogen to avoid exposure to the air. Several particles are selected from SEM images at 3000-fold magnification. Here, particles are selected such that a particle diameter distribution of the selected particles becomes as wide as possible.

Next, elemental analysis is performed on each selected particle by EDX. Accordingly, it is possible to specify species and quantities of elements other than Li among the elements contained in each selected particle.

The primary particle size and the secondary particle size of the active material particles can be determined using the above SEM observation images. A relationship between the primary particle size or the secondary particle size of the active material particles and the first peak and the second peak in the particle size distribution spectrum measured by the laser diffraction scattering method, which will be described later, can be speculated based on the SEM observation.

With regard to Li, information regarding the Li content in the entire active material can be obtained by ICP emission spectrometry. ICP emission spectrometry is performed according to the following procedure.

From the dried electrode, a powder sample is prepared in the following manner. The active material-containing layer is dislodged from the current collector and ground in a mortar. The ground sample is dissolved with acid to prepare a liquid sample. Here, hydrochloric acid, nitric acid, sulfuric acid, hydrogen fluoride, and the like may be used as the acid. The components included in the active material being measured can be found by subjecting the liquid sample to ICP emission spectroscopic analysis.

Crystal structure(s) of compound(s) included in each of the particles selected by SEM can be specified by XRD measurement. XRD measurement is performed within a measurement range where 2θ is from 5 degrees to 90 degrees, using CuKα ray as a radiation source. By this measurement, X-ray diffraction patterns of compounds contained in the selected particles can be obtained.

As an apparatus for XRD measurement, SmartLab manufactured by Rigaku is used. Measurement is performed under the following conditions:

X ray source: Cu target

Output: 45 kV, 200 mA

soller slit: 5 degrees in both incident light and received light

step width (2θ) : 0.02 deg

scan speed: 20 deg/min

semiconductor detector: D/teX Ultra 250

sample plate holder: flat glass sample plate holder (0.5 mm thick)

measurement range: range of 5°≤2θ≤90°

When another apparatus is used, measurement using a standard Si powder for powder X-ray diffraction is performed, conditions where measurement results of peak intensity, half-width, and diffraction angles equivalent to results obtained by the above apparatus are sought, and measurement of the sample is conducted at those conditions.

Conditions of the XRD measurement is set, such that an XRD pattern applicable to Rietveld analysis is obtained. In order to collect data for Rietveld analysis, specifically, the step width is made ⅓ to ⅕ of the minimum half width of the diffraction peaks, and the measurement time or X-ray intensity is appropriately adjusted in such a manner that the intensity at the peak position of strongest reflected intensity is 5,000 cps or more.

The XRD pattern obtained as described above is analyzed by the Rietveld method. In the Rietveld method, the diffraction pattern is calculated from the crystal structure model that has been estimated in advance. Here, estimation of the crystal structure model is performed based on analysis results of EDX and ICP. The parameters of the crystal structure (lattice constant, atomic coordinate, occupancy ratio, or the like) can be precisely analyzed by fitting all the calculated values with the measured values.

XRD measurement can be performed with the electrode sample directly attached onto a glass holder of a wide-angle X-ray diffraction apparatus. At this time, an XRD spectrum is measured in advance in accordance with the species of metal foil of the electrode current collector, and the position(s) of appearance of the peak(s) derived from the collector is grasped. In addition, the presence/absence of peak(s) of mixed substances such as an electro-conductive agent or a binder is also grasped in advance. If the peak(s) of the current collector overlaps the peak(s) of the active material, it is desirable to perform measurement with the active material-containing layer removed from the current collector. This is in order to separate the overlapping peaks when quantitatively measuring the peak intensities. If the overlapping peaks can be grasped beforehand, the above operations can be omitted, of course.

### Method of Measuring Particle Size Distribution

The particle size distribution of the particles included in the active material-containing layer can be measured by the laser diffraction scattering method.

The active material-containing layer is dissolved and dispersed in an aqueous solvent to prepare a slurry for measurement. Herein, the slurry for measurement is referred to as a “powder coating solution”.

The powder coating solution is prepared, for example, as follows. The active material-containing layer is dislodged from the current collector with, for example, a spatula. Hereupon, a powder of the material forming the active material-containing layer may be obtained. The powder-form sample is put into a measurement cell filled with an aqueous solvent until there is achieved a concentration at which measurement can be performed. The capacity of the measurement cell and the concentration at which measurement can be performed vary depending on the particle size distribution measurement apparatus. The measurement cell containing the aqueous solvent and the active material-containing layer sample dissolved therein is irradiated with ultrasonic waves for five minutes. The output of the ultrasonic waves is set, for example, in the range of 35 W to 45 W.

Alternatively, the active material-containing layer may be separated from the current collector by immersing the electrode directly in the aqueous solvent to dissolve the binder, instead of physically dislodging the active material-containing layer as described above. Alternatively, dislodging and dispersion of the active material-containing layer may be performed simultaneously by irradiating the electrode with ultrasonic waves while immersing the electrode in the aqueous solvent.

For example, pure water may be used as the aqueous solvent.

The measurement cell subjected to the ultrasonic treatment is put in the particle size distribution measurement apparatus and the particle size distribution is measured by the laser diffraction scattering method. As an example of the particle size distribution measurement apparatus, Microtrac MT3300EXII manufactured by MicrotracBEL Corp. can be cited. As the measurement conditions, the refractive index is set to 1.33, and the measurement mode is set to a reflection mode. Before the measurement is performed, ultrasonic irradiation is performed for 60 seconds.

### Production Method

The electrode can be fabricated by, for example, the following method. First, the thickener(s) is dissolved in an aqueous solvent. For example, pure water is used as the aqueous solvent. Then, the fibrous carbon material(s) is added to a solution thus obtained, followed by stirring of the solution. The stirring of the solution is performed using a thin-film swivel high-speed mixer at conditions of, for example, a circumferential velocity of 10 m/sec to 30 m/sec and a treatment amount of 3 L/hour to 10 L/hour. Subsequently, the active material(s) including the titanium-niobium composite oxide(s) is added to the solution, which is then further stirred under the same conditions. After the active material(s) including the titanium-niobium composite oxide(s), the fibrous carbon material(s), and the thickener(s) are dispersed in the solution in this manner, the electro-conductive agent(s) other than the fibrous carbon material(s) is optionally added to the solution, and more aqueous solvent is added to adjust the solid content ratio to 40% to 55%. Next, dispersion is performed using a bead mill apparatus. The dispersion using the bead mill is performed at conditions of a rotating speed of 500 rpm to 2000 rpm and a treatment amount of 1 L/hour to 3 L/hour. Subsequently, the binder(s) is added to the solution, and the solution is stirred using a planetary mixer at a condition of a rotating speed of 20 rpm to 45 rpm for 0.5 hour to 3 hours. The slurry for fabricating the electrode is thus prepared. By dispersing the active material(s), fibrous carbon material(s), and thickener(s) in the aqueous solvent in the initial stage, the agglomerate of the fibrous carbon materials can be resolved whereby the fibrous carbon materials can be dispersed so as to cover the active material particles, without crushing the active material particles. Also, in the case of including other electro-conductive agents, by adding the other electro-conductive agents and dispersing with the bead mill after forming the composite of the fibrous carbon material and the active material particles in this manner, the other electro-conductive agents can be dispersed among the composite.

The obtained slurry is applied onto one or both sides of the current collector. Next, the applied slurry is dried to obtain a stack of the active material-containing layer(s) and the current collector. Thereafter, the stack is pressed. In this manner, the electrode is fabricated.

By measuring the particle size distribution of the slurry for producing the electrode before applying the slurry onto the surface(s) of the current collector, the dispersion state of the materials such as the active material can be ascertained. It is preferable to use a slurry in which the active material and the fibrous carbon material are uniformly dispersed and agglomeration thereof is significantly reduced. Specifically, it is preferable to use a slurry having the following dispersion state to form the active material-containing layer(s).

In a preferred example of the slurry for producing the electrode, in a particle size distribution of the particles obtained by the laser diffraction scattering method, the average particle size D₅₀ is 1.1 μm to 2.4 μm, and the particle size D₀ [μm] corresponding to the peak top position P₀ of the maximum peak having a maximum peak intensity corresponding to the maximum frequency in the particle size distribution is in the range of D₅₀−0.1 μm≤D₀≤D₅₀+0.5 μm or less with respect to the average particle size D₅₀ [μm]. In other words, when the particle size distribution of the slurry is measured by the laser diffraction scattering method before applying the slurry onto the current collector for producing the electrode, if there is obtained a result showing that the average particle size measured is from 1.1 μm to 2.4 μm and the mode diameter does not differ greatly from the average particle size, it can be expected that the above-described configuration of the electrode according to the embodiment would be satisfied. In such a slurry where the average particle size and the mode diameter are close to each other, it can be determined that the active material and the fibrous carbon material hardly agglomerate.

In a more preferred example of the slurry for producing the electrode, the particle size D₁₀ at which cumulative frequency from the small particle size side is 10% in a particle size distribution of the particles obtained by the laser diffraction scattering method is from 0.3 μm to 0.6 μm. In another preferred example of the slurry for producing an electrode, the particle size D₉₀ at which cumulative frequency from the small particle size side is 90% in a particle size distribution of the particles obtained by the laser diffraction scattering method is from 4.0 μm to 5.8 μm. It is still more preferable to satisfy both ranges of the particle size D₁₀ and the particle size D₉₀.

The measurement of the particle size distribution of the slurry for producing an electrode can be performed in the same procedure and under the same conditions as those adopted in the measurement performed using the coating solution obtained by dissolving the active material-containing layer of the already-produced electrode. Specifically, irradiation with ultrasonic waves is performed for 60 seconds, and then the measurement is performed.

In the powder coating solution obtained by re-dissolving the active material-containing layer formed using the above slurry for producing an electrode, a particle size distribution different from the particle size distribution measured for the slurry before formation of the active material-containing layer is measured. Once the electrode materials (active material, fibrous carbon material, other electro-conductive agents, etc.) forming the active material-containing layer is dried, it is difficult to permeate the solvent into the interior of clusters of the respective components included in the solidified materials even if the solvent liquid is added again to the materials and the materials are irradiated with ultrasonic waves. Therefore, some of the clusters, such as a cluster formed by the active material tangling up in the fibrous carbon material, remains in the powder coating solution, which may result in an appearance of the second peak described above.

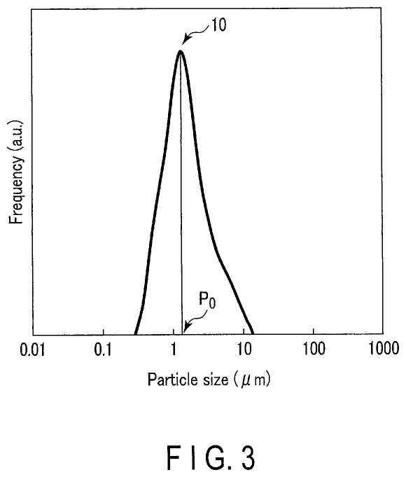

A particle size distribution of the preferred example of the slurry for producing the electrode is shown in FIG. 3. FIG. 3 is a graph showing a particle size distribution of an example of a slurry used to produce the electrode according to the embodiment. In the particle size distribution spectrum shown as an example, the particle size D₁₀ is 0.57 μm, the average particle size D₅₀ is 1.30 μm, and the particle size D₉₀ is 5.19 μm. The spectrum has a maximum peak 10 corresponding to a maximum value of the frequency of the particle size. A peak top position P₀ of the maximum peak 10 is at a position corresponding to the particle size of 1.26 μm. The particle size Do corresponding to the peak top position P₀ has a value of −0.4 μm with respect to the average particle size D₅₀ (1.26 μm−1.30 μm=−0.4 μm).

When an electrode is produced using the slurry for producing the electrode that shows the particle size distribution shown in FIG. 3, and a powder coating solution obtained by re-dissolving the electrode active material of the electrode thus obtained is subjected to a measurement according to the laser diffraction scattering method, the particle size distribution shown in FIG. 2 may be obtained.

The electrode according to the first embodiment includes an active material-containing layer including a titanium-niobium composite oxide, a fibrous carbon material, and a thickener. In the particle size distribution of the particles included in the active material-containing layer according to a laser diffraction scattering method, the average particle size D₅₀ is from 1.6 μm to 3.0 μm, the particle size D₁₀ at which cumulative frequency from the small particle size side is 10% is 1 μm or less, and the particle size D₉₀ at which cumulative frequency from the small particle size side is 90% is 10 μm or more. Also, the particle size distribution includes the first peak and the second peak. The first peak has a maximum peak intensity I_{MAX} corresponding to a maximum frequency in the particle size distribution. The position of the second peak in the particle size distribution is within a region corresponding to the particle size of 10 μm or more. The maximum peak intensity I_{MAX} and the peak intensity I_{2nd} of the second peak satisfy the relationship of I_{2nd}/I_{MAX}=0.25 to 0.7. The thickener is one or more selected from the group consisting of carboxymethyl cellulose, carboxymethyl cellulose salts, and polyvinyl pyrrolidone. The electrode according to the embodiment described above can provide a battery exhibiting excellent life performance.

### Second Embodiment

According to a second embodiment, there is provided a secondary battery including a positive electrode, a negative electrode, and an electrolyte. As the negative electrode, the secondary battery includes the electrode according to the first embodiment.

The secondary battery according to the second embodiment may further include a separator provided between the positive electrode and the negative electrode. The negative electrode, the positive electrode, and the separator may configure an electrode group. The electrolyte may be held in the electrode group.

The secondary battery according to the second embodiment may further include a container member that houses the electrode group and the electrolyte.

Moreover, the secondary battery according to the second embodiment may further include a negative electrode terminal electrically connected to the negative electrode and a positive electrode terminal electrically connected to the positive electrode.

The secondary battery according to the second embodiment may be, for example, a lithium secondary battery. The secondary battery also includes nonaqueous electrolyte secondary batteries containing nonaqueous electrolyte(s).

Hereinafter, the negative electrode, the positive electrode, the electrolyte, the separator, the container member, the negative electrode terminal, and the positive electrode terminal will be described in detail.

### 1) Negative Electrode

The negative electrode may include a negative electrode current collector and a negative electrode active material-containing layer. The negative electrode current collector and the negative electrode active material-containing layer may respectively be the current collector and active material-containing layer that may be included in the electrode according to the first embodiment.

Of the details of the negative electrode, sections overlapping with the details described in the first embodiment are omitted.

The density of the negative electrode active material-containing layer (excluding the current collector) is preferably from 1.8 g/cm³ to 2.8 g/cm³. The negative electrode, in which the density of the negative electrode active material-containing layer is within this range, is excellent in energy density and ability to hold the electrolyte. The density of the negative electrode active material-containing layer is more preferably from 2.1 g/cm³ to 2.6 g/cm³.

The negative electrode may be fabricated by the same method as that for the electrode according to the first embodiment, for example.

### 2) Positive Electrode

The positive electrode may include a positive electrode current collector and a positive electrode active material-containing layer. The positive electrode active material-containing layer may be formed on one surface or both of reverse surfaces of the positive electrode current collector. The positive electrode active material-containing layer may include a positive electrode active material, and optionally an electro-conductive agent and a binder.

As the positive electrode active material, for example, an oxide or a sulfide may be used. The positive electrode may singly include one species of compound as the positive electrode active material, or alternatively, include two or more species of compounds in combination. Examples of the oxide and sulfide include compounds capable of having Li and Li ions be inserted and extracted.

Examples of such compounds include manganese dioxides (MnO₂), iron oxides, copper oxides, nickel oxides, lithium manganese composite oxides (e.g., LiₚMn₂O₄ or LiₚMnO₂; 0<p≤1), lithium aluminum manganese composite oxide (e.g., LiₚAl_{q}Mn_{2-q}O₄; 0<p≤1, 0<q<1), lithium nickel composite oxides (e.g., LiₚNiO₂; 0<p≤1), lithium cobalt composite oxides (e.g., LiₚCoO₂; 0<p≤1), lithium nickel cobalt composite oxides (e.g., LiₚNi_{1-q}Co_{q}O₂; 0<p≤1, 0<q<1), lithium manganese cobalt composite oxides (e.g., LiₚMn_{q}Co_{1-q}O₂; 0<p≤1, 0<q<1), lithium manganese nickel composite oxides having a spinel structure (e.g., LiₚMn₂₋ₕNiₕO₄; 0<p≤1, 0<h<2), lithium phosphates having an olivine structure (e.g., LiₚFePO₄; 0<p≤1, LiₚMnPO₄; 0<p≤1, LiₚMn_{1-q}Fe_{q}PO₄; 0<p≤1, 0<q<1, LiₚCoPO₄; 0<p≤1), iron sulfates (Fe₂(SO₄)₃), vanadium oxides (e.g., V₂O₅), lithium nickel cobalt manganese composite oxides (LiₚNi_{1-q-r}Co_{q}MnᵣO₂; 0<p≤1, 0<q<1, 0<r<1, q+r<1), and lithium nickel cobalt aluminum composite oxide (e.g., LiNi_{1-q-r}Co_{q}AlᵣO₂; 0<q<1, 0<r<1, q+r<1).

Among the above, examples of compounds more preferable as the positive electrode active material include lithium manganese composite oxides having a spinel structure (e.g., LiₚMn₂O₄; 0<p≤1), lithium aluminum manganese composite oxide having a spinel structure (e.g., LiₚAl_{q}Mn_{2-q}O₄; 0<p≤1, 0<q<1), lithium nickel composite oxides (e.g., LiₚNiO₂; 0<p≤1), lithium cobalt composite oxides (e.g., LiₚCoO₂; 0<p≤1), lithium nickel cobalt composite oxides (e.g., LiₚNi_{1-q}Co_{q}O₂; 0<p≤1, 0<q<1), lithium manganese nickel composite oxides having a spinel structure (e.g. , LiₚMn₂₋ₕNiₕO₄; 0<p≤1, 0<h<2), lithium manganese cobalt composite oxides (e.g., LiₚMn_{q}Co_{1-q}O₂; 0<p≤1, 0<q<1), lithium iron phosphates (e.g., LiₚFePO₄; 0<p≤1), lithium nickel cobalt manganese composite oxides (LiₚNi_{1-q-r}Co_{q}MnᵣO₂; 0<p≤1, 0<q<1, 0<r<1, q+r<1), and lithium phosphates having an olivine structure (e.g., LiₚFePO₄; 0<p≤1, LiₚMnPO₄; 0<p≤1, LiₚMn_{1-q}Fe_{q}PO₄; 0<p≤1, 0<q<1, and LiₚCoPO₄; 0<p≤1). The positive electrode potential can be made high by using these positive electrode active materials.

When a room temperature molten salt is used as the electrolyte of the battery, it is preferable to use a positive electrode active material including lithium iron phosphate, Li_{b}VPO₄F (0≤b≤1), lithium manganese composite oxide, lithium nickel composite oxide, lithium nickel cobalt composite oxide, or a mixture thereof. Since these compounds have low reactivity with room temperature molten salts, cycle life can be improved. Details regarding the room temperature molten salt are described later.

The primary particle diameter of the positive electrode active material is preferably from 100 nm to 1 μm. The positive electrode active material having a primary particle size of 100 nm or more is easy to handle during industrial production. In the positive electrode active material having a primary particle size of 1 μm or less, in-solid diffusion of lithium ions can proceed smoothly.

The specific surface area of the positive electrode active material is preferably from 0.1 m²/g to 10 m²/g. The positive electrode active material having a specific surface area of 0.1 m²/g or more can secure sufficient sites for inserting and extracting Li ions. The positive electrode active material having a specific surface area of 10 m²/g or less is easy to handle during industrial production, and can secure a good charge-discharge cycle performance.

The binder is added to fill gaps among the dispersed positive electrode active material and also to bind the positive electrode active material with the positive electrode current collector. Examples of the binder include polytetrafluoroethylene (PTFE), polyvinylidene fluoride (PVdF), fluorine rubber, styrene-butadiene rubber (SBR), acrylic polymers, acrylic copolymers, polyacrylate compounds such as polyacrylate and polyacrylonitrile, imide compounds, polyimide, polyamide imide, polyvinyl alcohol, urethane polymers, urethane copolymers, carboxymethyl cellulose (CMC), and salts of CMC. One of these may be used as the binder, or alternatively, two or more may be used in combination as the binder.

The electro-conductive agent is added to improve current collection performance and to suppress the contact resistance between the positive electrode active material and the positive electrode current collector. Examples of electro-conductive agent include carbonaceous substances such as vapor grown carbon fiber (VGCF), carbon black such as acetylene black, graphite, graphene, carbon nanofiber, and carbon nanotube. One of these may be used as the electro-conductive agent, or two or more may be used in combination as the electro-conductive agent. The electro-conductive agent may be omitted.

In the positive electrode active material-containing layer, the positive electrode active material and binder are preferably blended in proportions of 80% by mass to 98% by mass, and 2% by mass to 20% by mass, respectively.

When the amount of the binder is 2% by mass or more, sufficient electrode strength can be achieved. The binder may serve as an electrical insulator. Thus, when the amount of the binder is 20% by mass or less, the amount of insulator in the electrode is reduced, and thereby the internal resistance can be decreased.

When an electro-conductive agent is added, the positive electrode active material, binder, and electro-conductive agent are preferably blended in proportions of 80% by mass to 95% by mass, 2% by mass to 17% by mass, and 3% by mass to 18% by mass, respectively.

When the amount of the electro-conductive agent is 3% by mass or more, the above-described effects can be expressed. By setting the amount of the electro-conductive agent to 18% by mass or less, the proportion of electro-conductive agent that contacts the electrolyte can be made low. When this proportion is low, decomposition of electrolyte can be reduced during storage under high temperatures.

The positive electrode current collector is preferably an aluminum foil, or an aluminum alloy foil containing one or more selected from the group consisting of Mg, Ti, Zn, Ni, Cr, Mn, Fe, Cu, and Si.

The thickness of the aluminum foil or aluminum alloy foil is preferably from 5 μm to 20 μm, and more preferably 15 μm or less. The purity of the aluminum foil is preferably 99% by mass or more. The amount of transition metal such as iron, copper, nickel, or chromium contained in the aluminum foil or aluminum alloy foil is preferably 1% by mass or less.

The positive electrode current collector may include a portion where a positive electrode active material-containing layer is not formed on a surface of thereof. This portion may serve as a positive electrode current collecting tab.

The positive electrode may be fabricated by the following method, for example. First, positive electrode active material, electro-conductive agent, and binder are suspended in a solvent to prepare a slurry. The slurry is applied onto one surface or both of reverse surfaces of a current collector. Next, the applied slurry is dried to form a stack of active material-containing layer(s) (positive electrode active material containing layer(s)) and current collector. Then, the stack is subjected to pressing. The positive electrode can be fabricated in this manner.

Alternatively, the positive electrode may also be fabricated by the following method. First, positive electrode active material, electro-conductive agent, and binder are mixed to obtain a mixture. Next, the mixture is formed into pellets.

Then the positive electrode can be obtained by arranging the pellets on the current collector.

### 3) Electrolyte

As the electrolyte, for example, a liquid nonaqueous electrolyte or gel nonaqueous electrolyte may be used. The liquid nonaqueous electrolyte is prepared by dissolving an electrolyte salt as solute in an organic solvent. The concentration of electrolyte salt is preferably from 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LiN(CF₃SO₂)₂], and mixtures thereof. The electrolyte salt is preferably resistant to oxidation even at a high potential, and most preferably LiPF₆.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolane (DOX); linear ethers such as dimethoxy ethane (DME) and diethoxy ethane (DEE); γ-butyrolactone (GBL), acetonitrile (AN), and sulfolane (SL). These organic solvents may be used singularly or as a mixed solvent.

Examples of more preferable organic solvents include mixed solvents where mixed are two or more selected from the group consisting of propylene carbonate (PC), ethylene carbonate (EC), diethyl carbonate (DEC), dimethyl carbonate (DMC), and methyl ethyl carbonate (MEC). By using such a mixed solvent, there can be obtained a nonaqueous electrolyte secondary battery that is excellent in charge-discharge performance. In addition, an additive other than the above described electrolyte salts may be added to the liquid electrolyte.

The gel nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Alternatively, other than the liquid nonaqueous electrolyte and gel nonaqueous electrolyte, a room temperature molten salt (ionic melt) including lithium ions, a polymer solid electrolyte, an inorganic solid electrolyte, or the like may be used as the nonaqueous electrolyte.

The room temperature molten salt (ionic melt) indicates compounds among organic salts made of combinations of organic cations and anions, which are able to exist in a liquid state at room temperature (15° C. to 25° C.). The room temperature molten salt includes a room temperature molten salt which exists alone as a liquid, a room temperature molten salt which becomes a liquid upon mixing with an electrolyte salt, a room temperature molten salt which becomes a liquid when dissolved in an organic solvent, and mixtures thereof. In general, the melting point of the room temperature molten salt used in secondary batteries is 25° C. or below. The organic cations generally have a quaternary ammonium framework.

The polymer solid electrolyte is prepared by dissolving the electrolyte salt in a polymeric material, and solidifying it.

The inorganic solid electrolyte is a solid substance having Li ion conductivity.

### 4) Separator

The separator may be made of, for example, a porous film or synthetic resin nonwoven fabric including polyethylene (PE), polypropylene (PP), polyethylene terephthalate (PET), cellulose, or polyvinylidene fluoride (PVdF). Other than that, there may be used separators where inorganic compounds or organic compounds are applied onto a porous film. In view of safety, a porous film made of polyethylene or polypropylene is preferred. This is because such a porous film melts at a fixed temperature and thus able to shut off current.

### 5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal container is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less. In a battery including such a metal container, drastic improvements in long-term reliability under high temperature environments and heat releasing properties become possible.

The shape of the container member is not particularly limited. The shape of the container member may be, for example, flat (thin), square, cylindrical, coin-shaped, button-shaped, sheet-shaped, and stack-shaped. The container member may be appropriately selected depending on battery size and use of the battery. For example, the container member may be a container member for small-sized batteries to be installed on mobile electronic devices and the like. The container member may be a container member for large-scale batteries to be installed on vehicles, such as two- to four-wheeled automobiles.

### 6) Negative electrode Terminal

The negative electrode terminal may be made of a material that is electrically stable within a potential range of 0.8 V to 3 V (vs. Li/Li⁺) relative to a redox potential of lithium, and having electrical conductivity. Specific examples of the material for the negative electrode terminal include copper, nickel, stainless steel, aluminum, and aluminum alloy containing at least one selected from the group consisting of Mg, Ti, Zn, Mn, Fe, Cu, and Si. Aluminum or aluminum alloy is preferred as the material for the negative electrode terminal. The negative electrode terminal is preferably made of the same material as the negative electrode current collector, in order to reduce contact resistance between the negative electrode terminal and the negative electrode current collector.

### 7) Positive Electrode Terminal

The positive electrode terminal may be made of, for example, a material that is electrically stable in the potential range of 3 V to 4.5 V (vs. Li/Li⁺) relative to the redox potential of lithium, and having electrical conductivity. Examples of the material for the positive electrode terminal include aluminum and an aluminum alloy containing one or more selected from the group consisting of Mg, Ti, Zn, Mn, Fe, Cu, and Si. The positive electrode terminal is preferably made of the same material as the positive electrode current collector, in order to reduce contact resistance between the positive electrode terminal and the positive electrode current collector.

Next, the secondary battery according to the second embodiment will be more concretely described with reference to the drawings.

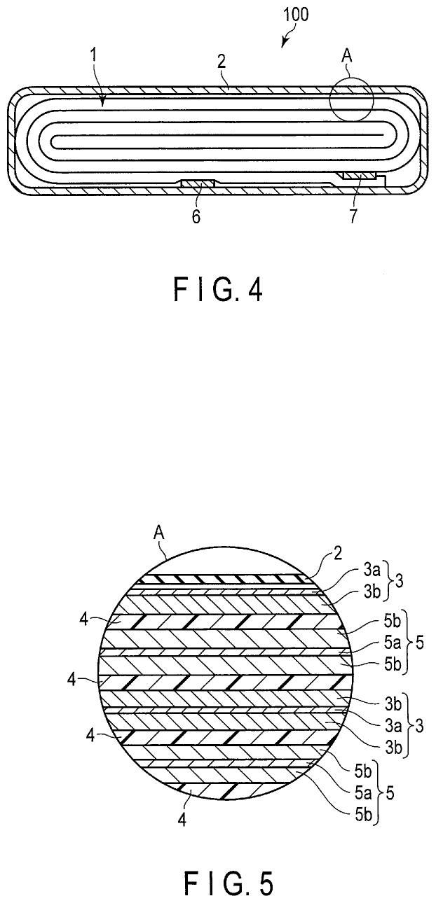

FIG. 4 is a cross-sectional view schematically showing an example of a secondary battery according to the second embodiment. FIG. 5 is an enlarged cross-sectional view of section A of the secondary battery shown in FIG. 4.

The secondary battery 100 shown in FIGS. 4 and 5 includes a bag-shaped container member 2 shown in FIG. 4, an electrode group 1 shown in FIGS. 4 and 5, and an electrolyte, which is not shown. The electrode group 1 and the electrolyte are housed in the bag-shaped container member 2. The electrolyte (not shown) is held in the electrode group 1.

The bag-shaped container member 2 is made of a laminate film including two resin layers and a metal layer sandwiched between the resin layers.

As shown in FIG. 4, the electrode group 1 is a wound electrode group in a flat form. The wound electrode group 1 in a flat form includes a negative electrode 3, a separator 4, and a positive electrode 5, as shown in FIG. 5. The separator 4 is sandwiched between the negative electrode 3 and the positive electrode 5.

The negative electrode 3 includes a negative electrode current collector 3a and a negative electrode active material-containing layer 3b. At the portion of the negative electrode 3 positioned outermost among the wound electrode group 1, the negative electrode active material-containing layer 3b is formed only on an inner surface of the negative electrode current collector 3a, as shown in FIG. 5. For the other portions of the negative electrode 3, negative electrode active material-containing layers 3b are formed on both of reverse surfaces of the negative electrode current collector 3a.

The positive electrode 5 includes a positive electrode current collector 5a and positive electrode active material-containing layers 5b formed on both of reverse surfaces of the positive electrode current collector 5a.

As shown in FIG. 4, a negative electrode terminal 6 and positive electrode terminal 7 are positioned in vicinity of the outer peripheral edge of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend out from an opening of the bag-shaped container member 2. A thermoplastic resin layer is provided on the inner surface of the bag-shaped container member 2, and the opening is sealed by heat-sealing the resin layer.

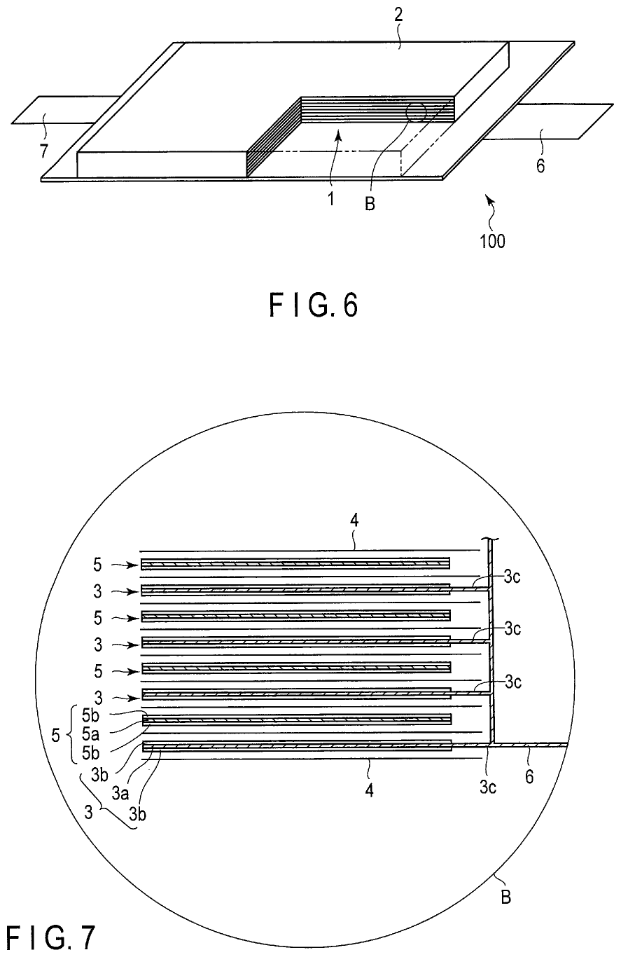

The secondary battery according to the second embodiment is not limited to the secondary battery of the structure shown in FIGS. 4 and 5, and may be, for example, a battery of a structure as shown in FIGS. 6 and 7.

FIG. 6 is a partially cut-out perspective view schematically showing another example of the secondary battery according to the second embodiment. FIG. 7 is an enlarged cross-sectional view of section B of the secondary battery shown in FIG. 6.

The secondary battery 100 shown in FIGS. 6 and 7 includes an electrode group 1 shown in FIGS. 6 and 7, a container member 2 shown in FIG. 6, and an electrolyte, which is not shown. The electrode group 1 and electrolyte are housed in the container member 2. The electrolyte is held in the electrode group 1.

The container member 2 is made of a laminate film including two resin layers and a metal layer sandwiched between the resin layers.

As shown in FIG. 7, the electrode group 1 is a stacked electrode group. The stacked electrode group 1 has a structure in which negative electrodes 3 and positive electrodes 5 are alternately stacked with separator(s) 4 sandwiched therebetween.

The electrode group 1 includes plural negative electrodes 3. Each of the negative electrodes 3 includes the negative electrode current collector 3a and the negative electrode active material-containing layers 3b supported on both surfaces of the negative electrode current collector 3a. The electrode group 1 further includes plural positive electrodes 5. Each of the positive electrodes 5 includes the positive electrode current collector 5a and the positive electrode active material-containing layers 5b supported on both surfaces of the positive electrode current collector 5a.

The negative electrode current collector 3a of each of the negative electrodes 3 includes at one end, a portion 3c where the negative electrode active material-containing layer 3b is not supported on either surface. This portion 3c serves as a negative electrode current collecting tab. As shown in FIG. 7, the portions 3c serving as the negative electrode current collecting tabs do not overlap the positive electrodes 5. The plural negative electrode current collecting tabs (portions 3c) are electrically connected to the strip-shaped negative electrode terminal 6. A tip of the strip-shaped negative electrode terminal 6 is drawn to the outside from the container member 2.

Although not shown, the positive electrode current collector 5a of each of the positive electrodes 5 includes at one end, a portion where the positive electrode active material-containing layer 5b is not supported on either surface. This portion serves as a positive electrode current collecting tab. Like the negative electrode current collecting tabs (portion 3c), the positive electrode current collecting tabs do not overlap the negative electrodes 3. Further, the positive electrode current collecting tabs are located on the opposite side of the electrode group 1 with respect to the negative electrode current collecting tabs (portion 3c). The positive electrode current collecting tabs are electrically connected to the strip-shaped positive electrode terminal 7. A tip of the strip-shaped positive electrode terminal 7 is located on the opposite side relative to the negative electrode terminal 6 and drawn to the outside from the container member 2.

The secondary battery according to the second embodiment includes the electrode according to the first embodiment. Thus, the secondary battery according to the second embodiment is excellent in life performance.

### Third Embodiment

According to a third embodiment, a battery module is provided. The battery module according to the third embodiment includes plural of secondary batteries according to the second embodiment.

In the battery module according to the third embodiment, each of the single-batteries may be arranged to be electrically connected in series or in parallel, or may be arranged in combination of in-series connection and in-parallel connection.

An example of the battery module according to the third embodiment will be described next, with reference to the drawings.

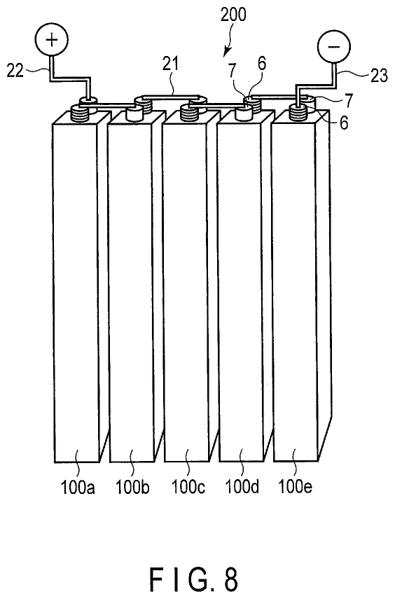

FIG. 8 is a perspective view schematically showing an example of the battery module according to the third embodiment. The battery module 200 shown in FIG. 8 includes five single-batteries 100a to 100e, four bus bars 21, a positive electrode-side lead 22, and a negative electrode-side lead 23. Each of the five single-batteries 100a to 100e is the secondary battery according to the second embodiment.

The bus bar 21 connects, for example, a negative electrode terminal 6 of one single-battery 100a and a positive electrode terminal 7 of the single-battery 100b positioned adjacent. In such a manner, five single-batteries 100 are thus connected in series by the four bus bars 21. That is, the battery module 200 shown in FIG. 8 is a battery module of five-in-series connection. Although no example is depicted in drawing, in a battery module including plural single-batteries that are electrically connected in parallel, for example, the plural single-batteries may be electrically connected by having plural negative electrode terminals being connected to each other by bus bars while having plural positive electrode terminals being connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the third embodiment includes the secondary battery according to the second embodiment. Therefore, the battery module is excellent in life performance.

### Fourth Embodiment

According to a fourth embodiment, a battery pack is provided. The battery pack includes a battery module according to the third embodiment The battery pack may include a single secondary battery according to the second embodiment, in place of the battery module according to the third embodiment.

The battery pack according to the fourth embodiment may further include a protective circuit. The protective circuit has a function to control charging and discharging of the secondary battery. Alternatively, a circuit included in equipment where the battery pack serves as a power source (for example, electronic devices, automobiles, and the like) may be used as the protective circuit for the battery pack.

Moreover, the battery pack according to the fourth embodiment may further include an external power distribution terminal. The external power distribution terminal is configured to externally output current from the secondary battery, and/or to input external current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the fourth embodiment will be described with reference to the drawings.

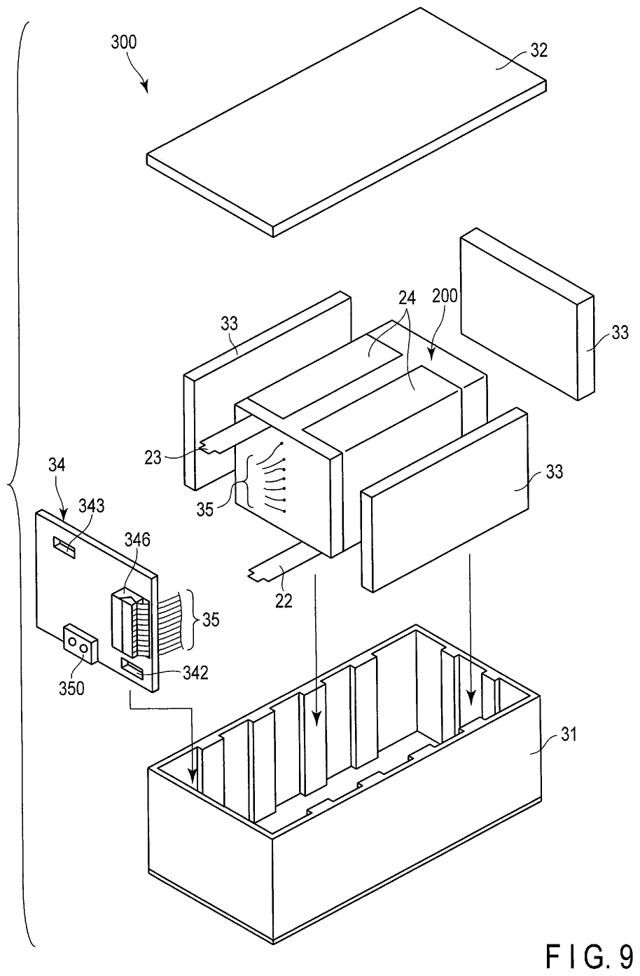

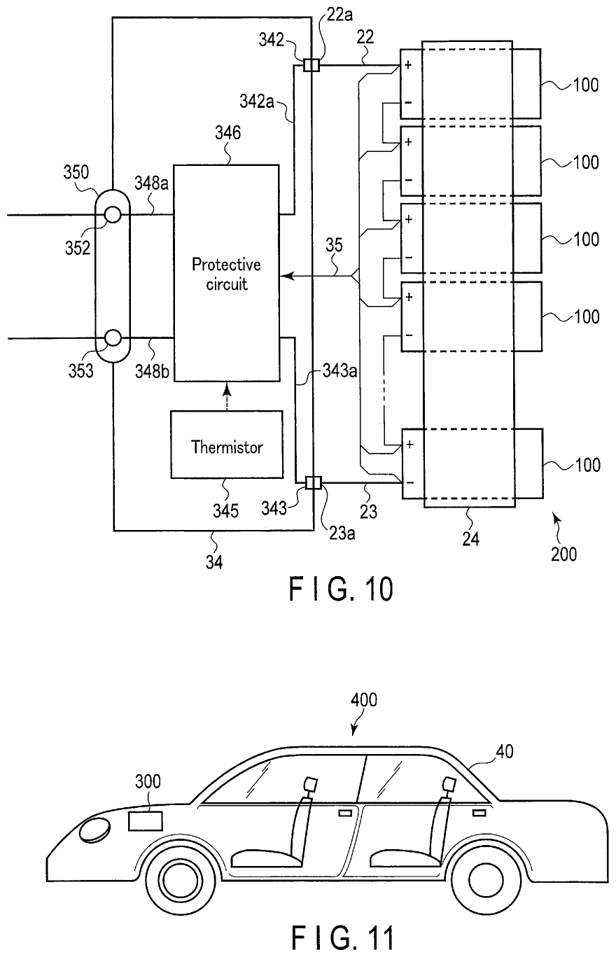

FIG. 9 is an exploded perspective view schematically showing an example of the battery pack according to the fourth embodiment. FIG. 10 is a block diagram showing an example of an electric circuit of the battery pack shown in FIG. 9.

A battery pack 300 shown in FIGS. 9 and 10 includes a housing container 31, a lid 32, protective sheets 33, a battery module 200, a printed wiring board 34, wires 35, and an insulating plate (not shown).

The housing container 31 shown in FIG. 9 is a square bottomed container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tape(s) 24.

At least one of the plural single-batteries 100 is a secondary battery according to the second embodiment. The plural single-batteries 100 are electrically connected in series, as shown in FIG. 10. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 24 fastens the plural single-batteries 100. The plural single-batteries 100 may be fixed using a heat shrinkable tape in place of the adhesive tape(s) 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces a surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34 . The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on the inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery(s) 100. When detecting over charge or the like for each of the single batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may respectively be used as the positive-side terminal and negative-side terminal of the external power distribution terminal.

Such a battery pack 300 is used, for example, in applications where excellent cycle performance is demanded when a large current is extracted. More specifically, the battery pack 300 is used as, for example, a power source for electronic devices, a stationary battery, or an onboard battery for various kinds of vehicles. An example of the electronic device is a digital camera. The battery pack 300 is particularly favorably used as an onboard battery.

The battery pack according to the fourth embodiment is provided with the secondary battery according to the second embodiment or the battery module according to the third embodiment. Accordingly, the battery pack is excellent in life performance.

### Fifth Embodiment

According to a fifth embodiment, a vehicle is provided. The battery pack according to the fourth embodiment is installed on this vehicle.

In the vehicle according to the fifth embodiment, the battery pack is configured, for example, to recover regenerative energy from motive force of the vehicle. The vehicle may include a mechanism (e.g., a regenerator) configured to convert kinetic energy of the vehicle into regenerative energy.

Examples of the vehicle according to the fifth embodiment include two-wheeled to four-wheeled hybrid electric automobiles, two-wheeled to four-wheeled electric automobiles, electrically assisted bicycles, and railway cars.

In the vehicle according to the fifth embodiment, the installing position of the battery pack is not particularly limited. For example, when installing the battery pack on an automobile, the battery pack may be installed in the engine compartment of the automobile, in rear parts of the vehicle body, or under seats.

The vehicle according to the fifth embodiment may have plural battery packs installed. In such a case, batteries included in each of the battery packs may be electrically connected to each other in series, electrically connected in parallel, or electrically connected in a combination of in-series connection and in-parallel connection. For example, in a case where each battery pack includes a battery module, the battery modules maybe electrically connected to each other in series, electrically connected in parallel, or electrically connected in a combination of in-series connection and in-parallel connection. Alternatively, in a case where each battery pack includes a single battery, each of the batteries may be electrically connected to each other in series, electrically connected in parallel, or electrically connected in a combination of in-series connection and in-parallel connection.

An example of the vehicle according to the fifth embodiment is explained below, with reference to the drawings.

FIG. 11 is a partially see-through diagram schematically showing an example of a vehicle according to the fifth embodiment.

A vehicle 400, shown in FIG. 11 includes a vehicle body 40 and a battery pack 300 according to the third embodiment. In the example shown in FIG. 11, the vehicle 400 is a four-wheeled automobile.

This vehicle 400 may have plural battery packs 300 installed. In such a case, the batteries (e.g., single-batteries or battery module) included in the battery packs 300 may be connected in series, connected in parallel, or connected in a combination of in-series connection and in-parallel connection.

In FIG. 11, depicted is an example where the battery pack 300 is installed in an engine compartment located at the front of the vehicle body 40. As mentioned above, for example, the battery pack 300 maybe alternatively installed in rear sections of the vehicle body 40, or under a seat. The battery pack 300 may be used as a power source of the vehicle 400. The battery pack 300 can also recover regenerative energy of motive force of the vehicle 400.

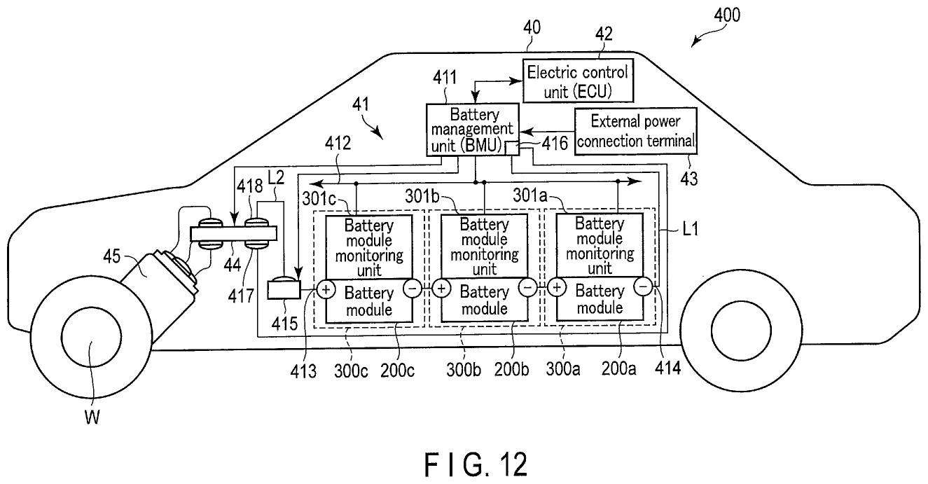

Next, with reference to FIG. 12, an aspect of operation of the vehicle according to the fifth embodiment is explained.

FIG. 12 is a diagram schematically showing an example of a control system related to an electric system in the vehicle according to the fifth embodiment. A vehicle 400, shown in FIG. 11, is an electric automobile.

The vehicle 400, shown in FIG. 12, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 12, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

The battery pack 300a includes a battery module 200a and a battery module monitoring unit 301a (e.g., a VTM: voltage temperature monitoring). The battery pack 300b includes a battery module 200b and a battery module monitoring unit 301b. The battery pack 300c includes a battery module 200c and a battery module monitoring unit 301c. The battery packs 300a to 300c are battery packs similar to the aforementioned battery pack 300, and the battery modules 200a to 200c are battery modules similar to the aforementioned battery module 200. The battery modules 200a to 200c are electrically connected in series. The battery packs 300a, 300b and 300c can each be independently removed, and may be exchanged by a different battery pack 300.

Each of the battery modules 200a to 200c includes plural single-batteries connected in series. At least one of the plural single-batteries is the secondary battery according to the second embodiment . The battery modules 200a to 200c each perform charging and discharging via a positive electrode terminal 413 and a negative electrode terminal 414.

The battery management unit 411 performs communication with the battery module monitoring units 301a to 301c and collects information such as voltages or temperatures for each of the single-batteries 100 included in the battery modules 200a to 200c included in the vehicle power source 41. In this manner, the battery management unit 411 collects information concerning security of the vehicle power source 41.

The battery management unit 411 and the battery module monitoring units 301a to 301c are connected via the communication bus 412. In the communication bus 412, a set of communication lines is shared at multiple nodes (i.e., the battery management unit 411 and one or more battery module monitoring units 301a to 301c). The communication bus 412 is, for example, a communication bus configured based on CAN (Control Area Network) standard.

The battery module monitoring units 301a to 301c measure a voltage and a temperature of each single-battery in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 12) for switching on and off electrical connection between the positive electrode terminal 413 and the negative electrode terminal 414. The switch unit 415 includes a precharge switch (not shown), which is turned on when the battery modules 200a to 200c are charged, and a main switch (not shown), which is turned on when output from the battery modules 200a to 200c is supplied to a load. The precharge switch and the main switch each include a relay circuit (not shown), which is switched on or off based on a signal provided to a coil disposed near the switch elements. The magnetic contactor such as the switch unit 415 is controlled based on control signals from the battery management unit 411 or the vehicle ECU 42, which controls the operation of the entire vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411 or the vehicle ECU 42, which controls the entire operation of the vehicle. Due to the inverter 44 being controlled, output voltage from the inverter 44 is adjusted.

The drive motor 45 is rotated by electric power supplied from the inverter 44. The drive generated by rotation of the motor 45 is transferred to an axle and driving wheels W via a differential gear unit, for example.

The vehicle 400 also includes a regenerative brake mechanism, though not shown. The regenerative brake mechanism (e.g., a regenerator) rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connecting line L1 is connected to the negative electrode terminal 414 of the vehicle power source 41. The other terminal of the connecting line L1 is connected to a negative electrode input terminal 417 of the inverter 44. A current detector (current detecting circuit) 416 in the battery management unit 411 is provided on the connecting line L1 in between the negative electrode terminal 414 and negative electrode input terminal 417.

One terminal of a connecting line L2 is connected to the positive electrode terminal 413 of the vehicle power source 41. The other terminal of the connecting line L2 is connected to a positive electrode input terminal 418 of the inverter 44. The switch unit 415 is provided on the connecting line L2 in between the positive electrode terminal 413 and the positive electrode input terminal 418.

The external terminal 43 is connected to the battery management unit 411. The external terminal 43 is able to connect, for example, to an external power source.

The vehicle ECU 42 performs cooperative control of the vehicle power source 41, switch unit 415, inverter 44, and the like, together with other management units and control units including the battery management unit 411 in response to inputs operated by a driver or the like. Through the cooperative control by the vehicle ECU 42 and the like, output of electric power from the vehicle power source 41, charging of the vehicle power source 41, and the like are controlled, thereby performing the management of the whole vehicle 400. Data concerning the security of the vehicle power source 41, such as a remaining capacity of the vehicle power source 41, are transferred between the battery management unit 411 and the vehicle ECU 42 via communication lines.

The vehicle according to the fifth embodiment is installed with the battery pack according to the fourth embodiment. Thus, by being provided with the battery pack with excellent life performance, reliability of the vehicle is high.

### EXAMPLES

Examples will be described hereinafter, but the embodiments of the present invention are not limited to the examples listed below, so long as the embodiments do not depart from the spirit of the invention.

### Example 1

TiNb₂O₇ (NTO) as an active material, acetylene black (AB) and carbon nanotube (CNT) as electro-conductive agents, carboxymethyl cellulose (CMC) and polyvinyl pyrrolidone (PVP) as thickeners, and styrene-butadiene rubber (SBR) as a binder, were provided. As the NTO active material, an active material in the form of primary particles having an average primary particle size of 1.5 μm was used. These materials were used in a proportion of 5 parts by mass of AB, 1 part by mass of CNT, 1 part by mass of CMC, 1 part by mass of PVP, and 2 parts by mass of SBR, with respect to 100 parts by mass of the NTO active material, to fabricate an electrode.

First, CMC and PVP were dissolved in water. At this time, CMC and PVP were dissolved so that the proportion of the solid material combining CMC and PVP became 2% by mass. Then, CNT was added to the solution in the above proportion, and the solution was stirred using a thin-film swivel high-speed mixer at a circumferential velocity of 20 m/sec and in a treatment amount of 5 L/hour. Thereafter, NTO was added to the solution, which was then stirred at a circumferential velocity of 20 m/sec in a treatment amount of 5 L/hour. After the NTO active material and CNT along with CMC and PVP were dispersed, AB was added in the above proportion. Thereafter, water was added so that the solid content ratio became 50%, and dispersion treatment was performed at 1000 rpm in a treatment amount of 2 L/hour using a bead mill apparatus. Then, SBR was added in the above proportion, and stirring was performed at 30 rpm for 1 hour using a planetary mixer, to thereby prepare a slurry.

When the particle size distribution of the obtained slurry was measured, the particle size distribution spectrum shown in the graph in FIG. 3 was obtained. In this spectrum, the average particle size D₅₀ was 1.30 μm, the particle size D₁₀ was 0.57 μm, and the particle size D₉₀ was 5.19 μm. Also, the spectrum included one peak having a peak top position corresponding to the particle size of 1.26 μm.

The prepared slurry was applied onto one face of a current collector made of an aluminum foil having a thickness of 15 μm, and the coating was dried. The coating amount of the slurry applied onto the current collector was 100 g/m². Thereby, a stack including the current collector and the active material-containing layer formed on the current collector was obtained. Subsequently, the obtained stack was subjected to roll-pressing to adjust the electrode density (excluding the current collector, i.e., the density of the active material-containing layer) to 2.5 g/cm³, thereby obtaining an electrode.

### Example 2

An electrode was fabricated by the same procedure as that described in Example 1, except that the conditions for the dispersion performed using a bead mill apparatus were changed so that the dispersion was performed at a treatment speed of 1500 rpm in a treatment amount of 2 L/hour.

### Example 3

An electrode was fabricated by the same procedure as that described in Example 1, except that the conditions for preparing a slurry were changed as follows.

First, CMC and PVP were dissolved in water. At this time, CMC and PVP were dissolved so that the proportion of the solid material combining CMC and PVP became 2% by mass. Then, CNT was added to the solution, and the solution was stirred using a thin-film swivel high-speed mixer at a circumferential velocity of 25 m/sec in a treatment amount of 5 L/hour. Thereafter, NTO was added to the solution, which was then stirred at a circumferential velocity of 25 m/sec in a treatment amount of 5 L/hour. After the NTO active material and CNT as well as CMC and PVP were dispersed, AB was added. Thereafter, water was added to the solution so that the solid content ratio became 50%, and dispersion was performed at 800 rpm in a treatment amount of 2 L/hour using a bead mill apparatus. Then, SBR was added, and stirring was performed at 30 rpm for 1 hour using a planetary mixer, to thereby prepare a slurry.

### Example 4

An electrode was fabricated by the same procedure as that described in Example 1, except that the thickener was changed to 2 parts by mass of carboxymethyl cellulose (CMC).

### Example 5

An electrode was fabricated by the same procedure as that described in Example 1, except that the thickener was changed to 2 parts by mass of carboxymethyl cellulose sodium (i.e., a sodium salt of CMC: CMCNa).

### Example 6

An electrode was fabricated by the same procedure as that described in Example 1, except that the thickener was changed to 2 parts by mass of polyvinyl pyrrolidone (PVP).

### Example 7

An electrode was fabricated by the same procedure as that described in Example 1, except that the thickener was changed to 1 part by mass of carboxymethyl cellulose sodium (CMCNa) and 2 parts by mass of polyvinyl pyrrolidone (PVP).

### Example 8

An electrode was fabricated by the same procedure as that described in Example 1, except that the electro-conductive agents other than the fibrous carbon material were changed to 4 parts by mass of acetylene black (AB) and 1 part by mass of graphite.

### Example 9

An electrode was fabricated by the same procedure as that described in Example 1, except that the electro-conductive agents other than the fibrous carbon material were changed to 4 parts by mass of acetylene black (AB) and 1 part by mass of graphite, and the binder was changed to 2 parts by mass of polyacrylic acid (PAA).

### Example 10

An electrode was fabricated by the same procedure as that described in Example 1, except that the electro-conductive agents other than the fibrous carbon material were changed to 4 parts by mass of acetylene black (AB) and 1 part by mass of graphite, and the binder was changed to 2 parts by mass of polyacrylonitrile (PAN).

### Comparative Example 1

TiNb₂O₇ (NTO) as an active material, acetylene black (AB) and carbon nanotube (CNT) as electro-conductive agents, carboxymethyl cellulose (CMC) and polyvinyl pyrrolidone (PVP) as thickeners, and styrene-butadiene rubber (SBR) as a binder, were provided. As the NTO active material, an active material in the form of primary particles having an average primary particle size of 1.5 μm was used. These materials were used in a proportion of 5 parts by mass of AB, 1 part by mass of CNT, 1 part by mass of CMC, 1 part by mass of PVP, and 2 parts by mass of SBR, with respect to 100 parts by mass of the NTO active material, to fabricate an electrode.

First, CMC and PVP were dissolved in water. At this time, CMC and PVP were dissolved so that the proportion of the solid material combining CMC and PVP became 2% by mass. Then, CNT was added to the solution in the above proportion, and the solution was stirred for 1 hour using a high-speed stirring apparatus with the stirring blade stirred at 500 rpm. Then, NTO and AB were added in the above proportion, and kneading was performed at 60 rpm for 1 hour using a planetary mixer. Thereafter, water was added so that the solid content ratio became 50%, and dispersion was performed at 1000 rpm for 2 hours using a bead mill apparatus. Then, SBR was added in the above proportion, and stirring was performed at 30 rpm for 1 hour using a planetary mixer, to thereby prepare a slurry.

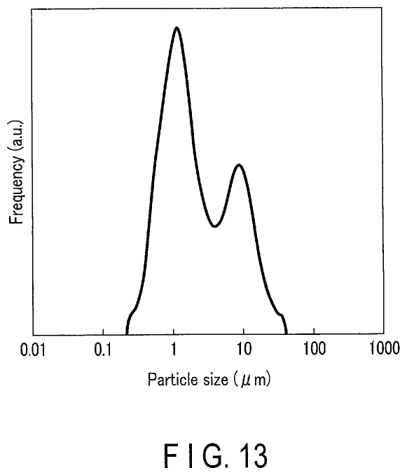

When the particle size distribution of the obtained slurry was measured, the particle size distribution spectrum shown in the graph in FIG. 13 was obtained. In this spectrum, the average particle size D₅₀ was 2 μm, the particle size D₁₀ was 0.67 μm, and the particle size D₉₀ was 12.2 μm. Two peaks were observed in the spectrum. The peak top of the first peak having a maximum intensity was at a position corresponding to 1.15 μm, and the peak top of the second peak was at a position corresponding to 0.25 μm. The peak intensity I2nd of the second peak had a value of 0.55 I_{MAX} with respect to the peak intensity I_{MAX} of the first peak (I_{2nd}/I_{MAX}=0.55).

The above slurry was applied onto one face of a current collector made of an aluminum foil having a thickness of 15 μm, and the coating was dried. The coating amount of the slurry applied onto the current collector was 100 g/m². Thereby, a stack including the current collector and the active material-containing layer formed on the current collector was obtained. Subsequently, the obtained stack was subjected to roll-pressing to adjust the electrode density (excluding the current collector) to 2.5 g/cm³, thereby obtaining an electrode.

### Comparative Example 2

An electrode was fabricated by the same procedure as that described in Example 1, except that the thickener was changed to 0.5 parts by mass of carboxymethyl cellulose (CMC) and 0.5 parts by mass of polyvinyl pyrrolidone (PVP)

### Comparative Example 3

An electrode was fabricated by the same procedure as that described in Example 1, except that carbon nanotube (CNT) was omitted and the electro-conductive agent was changed to 5 parts by mass of acetylene black (AB).

### Comparative Example 4

An electrode was fabricated by the same procedure as that described in Example 1, except that of the 100 parts by mass of the NTO active material, 70 parts by mass were kept as primary particles having an average primary particle size of 1.5 μm and 30 parts by mass were changed to primary particles having an average primary particle size of 12 μm.

### Comparative Example 5

An electrode was fabricated by the same procedure as that described in Example 1, except that of the 100 parts by mass of the NTO active material, 70 parts by mass were kept as primary particles having an average primary particle size of 1.5 μm and 30 parts by mass were made into secondary particles having an average secondary particle size of 12 μm.

### Measurement of Particle Size Distribution

For each of the above Examples and Comparative Examples, powder coatings were obtained by re-dissolving the active material-containing layer, and particle size distributions thereof were measured, by the method described above. In detail, first, the produced electrode was immersed in pure water to turn the active material-containing layer into a slurry. The particle size distribution of the slurry (powder coating) thus obtained was measured using a particle size distribution measurement apparatus (Microtrac MT3300EXII manufactured by MicrotracBEL Corp.). Pure water was used as a solvent, and the refractive index was set to 1.33. Also, ultrasonic irradiation was performed for 60 seconds before the measurement. The measurement was performed in a reflection mode.

In Example 1, the particle size distribution spectrum shown in the graph in FIG. 2 was obtained. In this spectrum, the average particle size D₅₀ was 2.39 μm, the particle size D₁₀ was 0.78 μm, and the particle size D₉₀ was 14.8 μm. The particle size distribution of Example 1 included two peaks having peak tops at a position near 1 μm and a position corresponding to 10 μm or more, respectively. Among the two peaks, the peak top of the peak positioned near 1 μm corresponded to the maximum frequency in the spectrum. The peak intensity I_{2nd} of the second peak with respect to the maximum peak intensity I_{MAX} of the first peak was 0.37 I_{MAX} I_{2nd}/I_{MAX}=0.37).

The details of the particle size distributions measured for the other Examples and Comparative Examples are shown later in Table 1.

### Evaluation

An electrochemical evaluation was performed on the electrode produced in each of the Examples and. Comparative Examples, as follows. For the electrochemical evaluation of the electrode, used was a three-electrode cell using lithium metal as a counter electrode and reference electrode. The electrodes were dried in a vacuum dryer at 130° C. for 12 hours, and then used to produce the three-electrode cell. Also, the assembling of the three-electrode cell was performed in a glove box filled with argon gas.

A liquid nonaqueous electrolyte prepared as follows was used as an electrolyte. First, ethylene carbonate (EC) and diethyl carbonate (DEC) were mixed at a volume ratio EC:DEC being 1:2, to obtain a mixed solvent. Lithium hexafluorophosphate LiPF₆ was dissolved in the mixed solvent at a concentration of 1 M to obtain the liquid nonaqueous electrolyte.

A 1 C charge-and-discharge cycling test was conducted in a 25° C. thermostat using the produced cell. As a current value of 1 C, a current value per active material weight was set to 270 mA/g. Regarding from charge at 1° C. to discharge at 1 C as one cycle, a total of 100 cycles of charge and discharge were performed.

Specifically, each charge-and-discharge cycle was performed as follows. First, the cell was charged until the potential of the working electrode reached 1.0 V (vs. Li/Li⁺) at a current value of 1 C (270 mA/g). After the potential reached 1.0 V (vs. Li/Li⁺), the cell was further charged until the current value reached 0.05 C while maintaining this potential. After the current value reached 0.05° C., the cell was discharged at a current value of 1 C until the potential reached 3.0 V (vs. Li/Li⁺).

A ratio of a discharge capacity C₁₀₀ in the 100th cycle relative to a discharge capacity C₁ in the initial cycle was calculated and determined as a capacity retention ratio (capacity retention ratio=[C₁₀₀/C₁]×100%).

The details of the particle size distributions measured for each of the Examples and Comparative Examples, and the results of the 1 C charge-and-discharge cycling test are shown in Table 1 below. As the details of the particle size distributions, shown are the particle size D₁₀, the average particle size D₅₀, the particle size D₉₀, and the peak intensity I_{2nd} of the second peak (the peak having a peak top in a region corresponding to 10 μm or more) with respect to the maximum peak intensity I_{MAX} of the first peak, which is the maximum intensity peak in the particle size distribution spectrum, in the particle size distributions. A discharge capacity retention ratio observed when performing 100 cycles of charge and discharge at 25° C. is shown as the result of the cycling test.

TABLE 1

| | | | | Peak | 100 Cycles |
|---|---|---|---|---|---|
| | | | | Intensity | Capacity |
| | | | | I_{2nd} of | Retention |
| | | | | Second | Ratio at |
| | D₁₀/μm | D₅₀/μm | D₉₀/μm | Peak/I_{MAX} | 25° C./% |
| Example 1 | 0.78 | 2.39 | 14.8 | 0.37 | 92 |
| Example 2 | 0.4 | 1.7 | 10.7 | 0.28 | 94 |
| Example 3 | 0.9 | 2.88 | 15.2 | 0.69 | 90 |
| Example 4 | 0.92 | 2.9 | 17.1 | 0.72 | 88 |
| Example 5 | 0.81 | 2.5 | 16.3 | 0.39 | 89 |
| Example 6 | 0.83 | 2.56 | 16.4 | 0.47 | 87 |
| Example 7 | 0.77 | 2.4 | 15 | 0.42 | 93 |
| Example 8 | 0.8 | 2.44 | 15.6 | 0.44 | 94 |
| Example 9 | 0.75 | 2.37 | 14.3 | 0.32 | 94 |
| Example 10 | 0.75 | 2.42 | 14.8 | 0.35 | 95 |
| Comparative | 1.7 | 5.3 | 22.1 | 0.8 | 80 |
| Example 1 | | | | | |
| Comparative | 1.2 | 3.8 | 19.9 | 0.77 | 78 |
| Example 2 | | | | | |
| Comparative | 1.3 | 3.5 | 18.4 | 0.75 | 75 |
| Example 3 | | | | | |
| Comparative | 2 | 4.2 | 25.6 | 1.2 | 79 |
| Example 4 | | | | | |
| Comparative | 1.5 | 3.9 | 21.7 | 0.95 | 74 |
| Example 5 | | | | | |

In Examples 1 to 10, particle size distributions were obtained in which the average particle size D₅₀ was 1.6 μm to 3.0 μm, the particle size D₁₀ at 10% cumulative frequency from the small particle size side was 1 μm or less, and the particle size D₉₀ at 90% cumulative frequency from the small particle size side was 10 μm or more, and which included the second peak having a peak intensity I_{2nd} of 0.25 I_{MAX} to 0.7 I_{MAX} with respect to the maximum peak intensity I_{MAX}, as shown in Table 1. In addition, the three-electrode cells which used the electrodes produced in Examples 1 to 10 achieved a high capacity retention ratio, as demonstrated by the results of the cycling test shown in Table 1. This demonstrates that a battery with excellent life performance can be realized by using the electrode which shows the particle size distribution described above.

In contrast, in Comparative Examples 1 to 5, the particle size D₁₀ exceeded 1 μm, the average particle size D₅₀ exceeded 3 μm, and even the peak intensity I_{2nd} of the second peak exceeded 0.7 I_{MAX}, in the particle size distribution, as shown in Table 1. It is determined that in Comparative Examples 1 to 5, the particles had agglomerated excessively within the active material-containing layer. As demonstrated by the results of the cycling test shown in Table 1, the cells which used the electrodes produced in Comparative Examples 1 to 5 exhibited capacity retention ratios lower than those of Examples 1 to 10.

According to at least one embodiment and example described above, provided is an electrode including an active material-containing layer. The active material-containing layer includes a titanium-niobium composite oxide, a fibrous carbon material, and one or more thickener selected from the group consisting of carboxymethyl cellulose, carboxymethyl cellulose salts, and polyvinyl pyrrolidone. In a particle size distribution for particles included in the active material-containing layer according to a laser diffraction scattering method, an average particle size D₅₀ is from 1.6 μm to 3.0 μm, a particle size D₁₀ at which cumulative frequency from a small particle size side is 10% is 1 μm or less, and a particle size D₉₀ at which cumulative frequency from the small particle size side is 90% is 10 μm or more. In addition, the particle size distribution includes a first peak having a maximum peak intensity I_{MAX} corresponding to a maximum frequency in the particle size distribution and a second peak positioned at 10 μm or more. The second peak has a peak intensity I_{2nd} of 0.25 I_{MAX} to 0.7 I_{MAX} with respect to the maximum peak intensity I_{MAX}. According to an electrode with such a configuration, there can be provided a battery and battery pack with excellent life performance and a vehicle having the battery pack installed thereon.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such embodiments or modifications as would fall within the scope and spirit of the inventions.

What is claimed is:

1. An electrode comprising an active material-containing layer, the active material-containing layer comprising:
a titanium-niobium composite oxide;
a fibrous carbon material; and
one or more thickener selected from the group consisting of carboxymethyl cellulose, carboxymethyl cellulose salts, and polyvinyl pyrrolidone,
in a particle size distribution of particles included in the active material-containing layer according to a laser diffraction scattering method, an average particle size D₅₀ being from 1.6 μm to 3.0 μm, a particle size D₁₀ at which cumulative frequency from a small particle size side is 10% being 1 μm or less, and a particle size D₉₀ at which cumulative frequency from the small particle size side is 90% being 10 μm or more, the particle size distribution includes a first peak having a maximum peak intensity I_{MAX} corresponding to a maximum frequency in the particle size distribution and a second peak positioned at 10 μm or more, and the second peak has a peak intensity I_{2nd} of 0.25 I_{MAX} to 0.7 I_{MAX} with respect to the maximum peak intensity I_{MAX}.

2. The electrode according to claim 1, wherein the titanium-niobium composite oxide comprises a compound having a monoclinic crystal structure and being represented by general formula LiₐTi₁₋ₓM1ₓNb_{2-y}M2_{y}O_{y-δ}, where 0≤a<5, 0≤x<1, 0≤y<1, −0.3≤δ≤0.3, and element M1 and element M2 each being at least one selected from the group consisting of Mg, Fe, Ni, Co, W, Ta and Mo, the element M1 and the element M2 being same or different with one another.

3. A secondary battery comprising:
a positive electrode;
a negative electrode; and
an electrolyte,
the negative electrode comprising the electrode according to claim 1.

4. A battery pack comprising the secondary battery according to claim 3.

5. The battery pack according to claim 4, further comprising an external power distribution terminal and a protective circuit.

6. The battery pack according to claim 4, comprising plural of the secondary battery, the secondary batteries being electrically connected in series, in parallel, or in combination of in-series connection and in-parallel connection.

7. A vehicle comprising the battery pack according to claim 4.

8. The vehicle according to claim 7, wherein the vehicle comprises a mechanism configured to convert kinetic energy of the vehicle into regenerative energy.
